(19) United States
(12) Patent Application Publication
(10) Pub. No.: US 2004/0022211 A1
(43) Pub. Date: Feb. 5, 2004

(54) Radio-frequency switching device, in particular for mobile cellular telephones

(75) Inventor: Patrick Conti, St-Jean De Tholome (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics N.V., Amsterdam (NL)

(21) Appl. No.: 10/606,189

(22) Filed: Jun. 25, 2003

(30) Foreign Application Priority Data
Jun. 26, 2002 (EP) 02014220.4

(51) Int. Cl. H04B 7/00

(52) U.S. Cl. 370/328; 370/310

(57) ABSTRACT

A radio-frequency switching device includes first and second radio-frequency channels connected to an input/output terminal. A controllable switching device selects one of the radio-frequency channels in response to a switching control signal. The switching device includes a respective control module connected to each radio-frequency channel. Each control module includes a PIN diode whose cathode is connected to the input/output terminal, and a control transistor whose base is connected to a control input for receiving the switching control signal. A conducting terminal of the control transistor is connected to the anode of the PIN diode.

### FIELD OF THE INVENTION

The present invention relates to radio-frequency switching devices, and in particular, to those incorporated in wireless communication system terminals, such as mobile cellular telephones operating under different transmission standards (GSM, DCS, PCS, WCDMA, etc.).

### BACKGROUND OF THE INVENTION

When a terminal such as a mobile cellular telephone is designed to operate with different transmission standards, an antenna switching device is required. The antenna switching device selectively switches the reception and/or transmission channels dedicated to each standard to an antenna.

Traditional radio-frequency switching devices are based on PIN diodes, a line biplexer and quarter wave transmission lines, as readily understood by those skilled in the art. A PIN diode is formed by a P⁺region, an N⁺region and a region of intrinsic semiconductor material between the P⁺and N⁺regions.

Such devices have size disadvantages, in particular, due to the high number of very high quality inductors (seven for a five pole switching device) and capacitors. This also significantly increases the cost of the finished product.

### SUMMARY OF THE INVENTION

In view of the foregoing background, an object of the present invention is to provide a relatively straightforward and inexpensive radio-frequency switching device that is also compact.

Another object of the present invention is to provide a radio-frequency switching device having very good radio-frequency isolation when one of the radio-frequency channels is selected in order to reduce the loss of energy in the selected channel.

These and other objects, advantages and features in accordance with the present invention are provided by a radio-frequency switching device comprising at least a first radio-frequency channel and a second radio-frequency channel connected together at an input/output terminal. The radio-frequency switching device may further comprise an antenna, and controllable switching means for selecting one of the radio-frequency channels in response to a switching control signal.

According to one general characteristic of the invention, the switching means may comprise a control module for each radio-frequency channel. Each control module may comprise a PIN diode whose cathode is connected to the input/output terminal, and a control transistor whose base is connected to an input control that receives the switching control signal. Furthermore, the sink (collector) of this control transistor may be connected to the anode of the PIN diode for forming the common node between the PIN anode intersections. According to a preferred embodiment, the control transistor comprises a lateral PNP transistor.

The radio-frequency switching device may have more than two radio-frequency channels connected together at the input/output terminal. For example, it may comprise five radio-frequency channels, thus forming a device with five poles that is much more compact and less expensive than a five pole device of the prior art.

The radio-frequency switching device may advantageously be in the form of an integrated circuit. In one application of wireless communications, the input/output terminal may have a radio-frequency antenna, and the radio-frequency channels may have dedicated transmission channels and dedicated reception channels.

To adapt to multi-standard transmissions, the radio-frequency switching device advantageously includes channels respectively dedicated to different transmission standards operating at different frequencies. These channels include those dedicated to GSM reception and transmission, DCS/PCS reception and transmission, and WCDMA reception and transmission, for example.

Another aspect of the present invention is directed to a terminal that is remote from the wireless communication system, such as a mobile cellular telephone comprising a radio-frequency switching device as described above.

### BRIEF DESCRIPTION OF THE DRAWINGS

Other advantages and characteristics of the invention will become clear upon reading the detailed description of the embodiments, which are in no way restrictive, and the appended drawings, in which:

FIG. 1 is a diagrammatic representation of an embodiment of a radio-frequency switching device according to the present invention;

FIG. 2 is a diagrammatic representation of a transistor for controlling a device according to the present invention;

FIG. 3 is a diagrammatic representation of the equivalent circuit of the transistor illustrated in FIG. 2;.

FIG. 4 is a more detailed diagrammatic representation of a device control module according to the present invention; and

FIG. 5 is another diagrammatic and partial representation of a device control module according to the present invention.

### DETAILED DESCRIPTION OF THE PREFERRED EMBODIMENTS

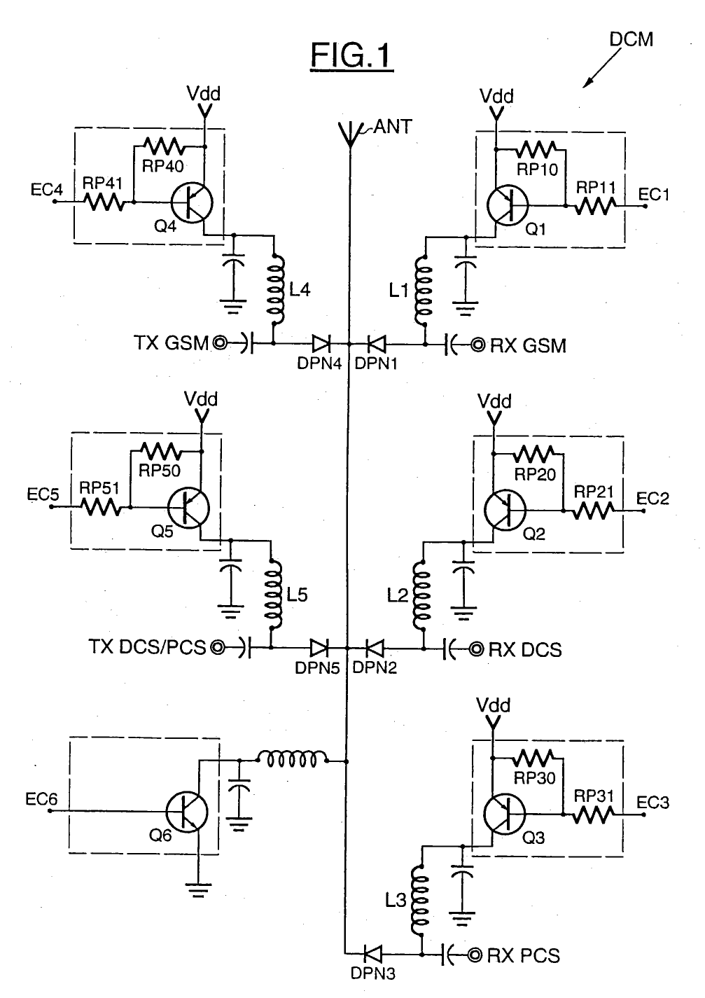

In FIG. 1, the DCM reference designates a radio-frequency switching device integrated, for example, in a mobile cellular telephone capable of operating to the GSM, DCS or PCS standards. This switching device DCM comprises an antenna ANT as well as five radio-frequency channels, respectively referenced as follows: TXGSM for the transmission channel using the GSM standard; RXGSM for the reception channel using the GSM standard; TXDCS/PCS for the transmission channel using the DCS or PCS standard; RXDCS for the reception channel using the DCS standard; and RXPCS for the reception channel using the PCS standard.

FIG. 1 diagrammatically shows these radio-frequency channels by a double circle, such as the RXGSM channel, for example. Each of these channels includes a frequency transposition device, a low interference amplifier with controlled gain levels, as well as an analog/digital and digital/analog converter linked to the telephone's digital processor. In particular, the processor carries out the basic frequency band processing, such as channel decoding, channel encoding, source decoding and source encoding.

The switching device DCM further comprises switching means that can be controlled by the mobile telephone's processor, so that one of these radio-frequency channels may be selected in response to a switching control signal. The controllable switching means comprises a control module for each radio-frequency channel. More precisely, each control module, such as the module connected to the RXGSM radio-frequency module, comprises a PIN diode referenced DPN1, whose-cathode is connected to the antenna ANT. The anode of this PIN diode is connected to the radio-frequency channel RXGSM via a capacitor.

A PIN diode is formed by a P⁺region, and an N⁺region surrounding an intrinsic semi-conductor material, as readily understood by those skilled in the art. When such a diode is directly biased, charge carriers appear in the intrinsic region which then becomes conductive. However, when the diode is reversed biased, these charge carriers disappear from the intrinsic region which remains resistive. At low frequencies, a PIN diode operates like a variable resistor that depends on the biasing current. The threshold frequency of the PIN diode is chosen so that it is much lower than the frequencies used in the various transmission standards.

Apart from this diode DPN1, the control module that is on the RXGSM channel comprises a control transistor Q1, which in this case is a PNP type lateral transistor. The transistor Q1 sink (collector) is connected to the anode of the diode DPN1 via a shock inductor L1, whose function is to allow the DC current to pass and to resist the high frequency current. The transistor Q1 sink is furthermore connected to ground via another capacitor.

The transistor Q1 emitter is connected to the supply voltage Vdd and its base is connected to an input control EC1 that receives the logic switching control signal. Two biasing resistors RP10 and RP11 provide the biasing current for the transistor Q1.

The other control modules, respectively connected to the other radio-frequency channels, are identical to that which has just been described. Apart from the switching modules, the CM module also comprises an NPN transistor referenced Q6 whose sink is connected to the antenna and whose transmitter (emitter) is connected to ground. The base of this transistor Q6 is connected to another control input EC6 that receives a transmission/reception switching signal. The transistor Q6 operates as a current source to limit the current to about 300 mA in the reception mode, and at about 4 mA in the transmission mode, for example.

The transmission/reception switching signal is consequently a signal capable of taking two values, in order to give the transmission mode a higher current than the reception mode. The current values given above are such that in the reception mode the power consumption of the receiver is not penalized while also maintaining a resistance of the PIN diodes sufficiently low for low amplitude RF signals.

For example, when the TXGSM radio-frequency channel is to be selected, which is to say the transmission cannel dedicated to the GSM standard, the telephone processor applies a switching control signal having a logic value of 0 to the EC4 control input and a logic value 1 to the EC1, EC2, EC3 and EC5 control inputs. Consequently, the transistor Q4 allows the current to pass and the DC current conducts from the Vdd supply to ground via the transistor Q4, the inductor L4, the diode DP4 and the transistor Q6.

The diode DPN4 is in a state of low resistance, whereas all of the other PIN diodes are in a high resistance state, thus isolating the other radio-frequency channels. Furthermore, in this configuration, the switching signal supplied to the input EC6 is in its low logic state in order to allow the conduction of a high current, for example, 4 mA.

It is especially important to obtain good isolation of the other channels that are not selected Thus, when a transmission mode is selected, for example, all of the other channels are in parallel in their high isolation mode. Any deterioration to this isolation will have a direct affect on the loss of energy from the channel selected.

Thus, by way of example, when the GSM channel is selected, the peak/peak voltage at the antenna connector is +/−15 Volts for a GSM power of around 36 dBm. Since the cathodes of the PIN diodes of the channels not selected can see this signal, current leaks can arise through these PIN diodes. In this example the diodes DPN1, DPN2, DPN3 and DPN5 in the corresponding control transistors have an equivalent diode biased in the same direction. This would be the case for NPN type transistors, or possibly for PNP type control transistors with electrostatic discharge protection diodes (ESD protection) as part of the integrated circuit.

In this case, the isolation could be very low with a loss of around 6 dB in the transmission channel selected, which is not acceptable. An approach to this problem could then be to apply a negative voltage equal to the peak voltage (−15 Volts) to the anode of each of the PIN diodes not selected in order to reverse bias these diodes. However, such an approach is not possible in a mobile telephone, in which the supply voltage Vdd is low, which is typically equal to 2.7 Volts.

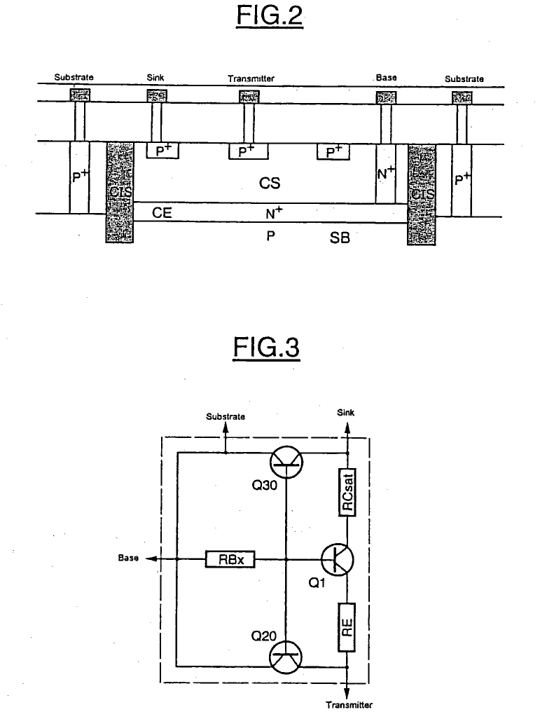

The invention addresses this problem by combining with the PIN diode a control transistor whose sink is connected to the anode of this PIN diode. The sink is seen as forming the common node between the two PIN intersection anodes. One approach for creating such a transistor is to use a PNP lateral transistor as shown in FIG. 2.

This transistor is, in this case, in an N doped casing CS separated from the P doped substrate SB by an N⁺doped buried layer CE. This layer CE is in contact with the base via an N⁺well. The casing CS forming the active zone of the transistor is isolated from the rest of the substrate SB by lateral isolation casings CIS. P⁺wells allow the substrate to be biased.

The sink (collector) and transmitter (emitter) regions, the P⁺doped regions, and the corresponding contacts are also housed inside the CS casing. Electrically, the equivalent diagram of this lateral transistor Q1 is illustrated in FIG. 3. In this figure, the transistor Q1 designates the lateral transistor, whereas the transistors Q20 and Q30 represent PNP type parasitic transistors.

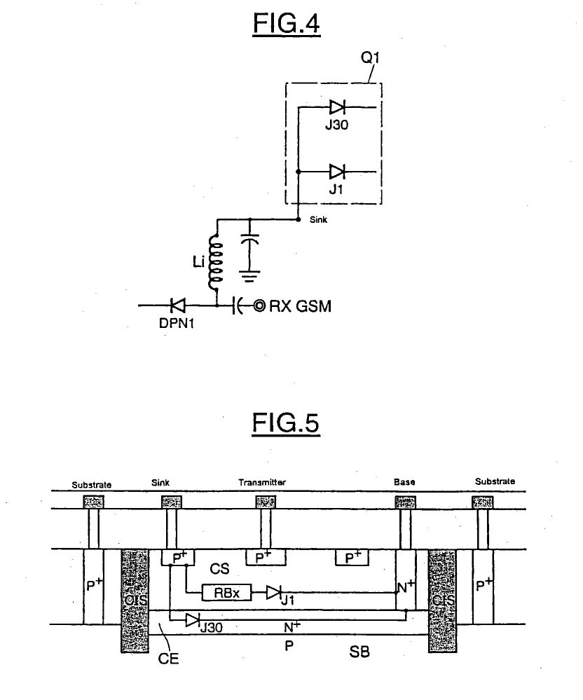

It can therefore be seen, by referring more particularly to FIG. 4, that, in this case, the transistor Q1 sink is seen as forming the common node between the anode of the intersection of PN (diode) J1 formed by the sink/base of transistor Q1, and PN (diode) J30 of the parasitic transistor Q30. These various intersections are also shown in FIG. 5.

Consequently, since the anode of the PIN diode, referenced DPN1, and the anodes of the equivalent diodes of the Qi transistor, which is the anodes of diodes J1 and J30, are connected together, there is no current likely to pass through the diode DPN. This is regardless of the voltage applied to the cathode of the DPN1 diode when-the control transistor Q1 is blocked.

The diode DPNl therefore remains in its reversed biased state, maintaining a high resistive value. The isolation is not affected, even at high power. Consequently, the energy losses in the active channel selected remain below 0.5 dB, which is very acceptable. Of course, the rationale that has been applied here for the diode DPN1 and the transistor Q1 applies to the PIN diodes of the channels not selected, and for the corresponding control transistors.

The combination of PIN diodes with their cathodes connected together, and controlled in series by PNP lateral transistors, avoids the use of a biplexer and quarter wave transmission lines. This results in a substantial savings in passive components such as a five pole radio-frequency switching device as illustrated in FIG. 1, and results in seven high quality inductors and fifteen capacitors not being used. Furthermore, the device avoids the use of a high negative supply voltage to maintain a good level of performance. The use of PIN diodes with common cathodes means that they can be incorporated onto the same integrated circuit board, this reducing its size.

That which is claimed is:

1. Radio-frequency switching device, comprising at least a first radio-frequency channel and a second radio-frequency channel connected together at an input/output terminal, and controllable switching means that can select one of the radio-frequency channels in response to a switching control signal, characterised by the fact that the switching means comprise a control module connected to each radio-frequency channel, each control module comprising a PIN diode (DPNi) whose cathode is connected to the input/output terminal (ANT), and a control transistor (Qi) whose base is connected to an input control (Eci) designed to receive the switching control signal, and whose sink is connected to the anode of the PIN diode, and by the fact that the control transistor sink (Qi) is seen as forming the common node between the PN anode intersections.

2. Device of claim 1, characterised by the fact that the control transistor (Qi) is a lateral PNP transistor.

3. Device of claim 1 or 2, characterised by the fact that it comprises more than two radio-frequency channels connected together to the input/output terminal (ANT).

4. Device of any of the previous claims, characterised by the fact that it is made in the form of an integrated circuit.

5. Device of any of the previous claims, characterised by the fact that the input/output terminal comprises a radio-frequency antenna (ANT) and by the fact that the radio-frequency channels have channels dedicated to transmission and channels dedicated to reception.

6. Device of claim 5, characterised by the fact that it has channels respectively dedicated to the different transmission standards which have different frequencies.

7. Terminal that is remote from a cordless communication system, characterised by the fact that it comprises a device according to any of claims 1 to 6.

8. Remote terminal according to claim 7, characterised by the fact that it is a mobile cellular telephone.
